(19) United States
(12) Patent Application Publication
(10) Pub. No.: US 2006/0022985 A1
(43) Pub. Date: Feb. 2, 2006

(54) Preemptive rendering arbitration between processor hosts and display controllers

(75) Inventors: Thomas J. Shepherd, McKinney, TX (US); Minh G. Chau, Carrollton, TX (US); Prabha K. Atluri, Plano, TX (US); Sang-Won Song, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/903,750

(22) Filed: Jul. 30, 2004

(51) Int. Cl. G06F 13/18; G09G 5/36

(52) U.S. Cl. 345/535; 345/558

(57) ABSTRACT

A system comprises a display controller adapted to monitor a first-in, first-out module (“FIFO”) data level, a memory controller coupled to said display controller, and a memory coupled to said display controller and said memory controller. The memory controller permits the display controller to immediately access the memory when the FIFO data level drops below a pre-determined threshold level and no display panel horizontal or vertical blanking periods are in progress.

### BACKGROUND

A system-on-chip (“SoC”) device that is contained within an electronic system integrates some or most of the functions of that electronic system onto a single chip. For example, a typical SoC may group onto a single chip at least one processing element (e.g., microprocessor, DSP), peripherals, circuit logic and interfaces. On the same chip, the SoC also may have a bus-based architecture and contain both memory and analog functions, although such chips need not be limited to these elements. The ability to integrate the functions of an electronic device onto a single chip makes it possible to create complex electronic systems (e.g., miniature cell phones, miniature digital cameras and miniature personal digital assistants) that are substantially small and portable, use less power and are more reliable than traditional electronic devices.

An increase in the use of SoC devices in such commercial products has resulted in considerable market demand for products that deliver substantial multimedia display capabilities, such as high-powered streaming video capability, video-based messages, video files and/or high-resolution graphics. Designers must improve hardware functionality to satisfy this demand. However, with limited SoC hardware options, designers are often forced to choose between increasing application performance by allowing multiprocessors (e.g., ARM, DSP and Graphic Accelerators) to access program code from memory, and increasing visual display performance (e.g., streaming video) by enabling a display controller to access memory and obtain pixel data that may be displayed on a display panel. Thus, to date, designers are seemingly unable to improve both application and video performance speeds to deliver high-powered multimedia display capabilities.

### BRIEF SUMMARY

The problems noted above are solved in large part by a system that implements a preemptive memory access arbitration scheme in a system-on-chip device. In at least some embodiments, the system comprises a display controller adapted to monitor a first-in, first-out module (“FIFO”) data level, a memory controller coupled to said display controller, and a memory coupled to said display controller and said memory controller. The memory controller permits the display controller to immediately access the memory when the FIFO data level drops below a pre-determined threshold level and no display panel horizontal or vertical blanking periods are in progress.

### BRIEF DESCRIPTION OF THE DRAWINGS

For a detailed description of exemplary embodiments of the invention, reference will now be made to the accompanying drawings in which:

FIG. 1 shows a system-on-chip device coupled to a display panel in accordance with embodiments of the invention;

FIG. 2a shows a horizontal and vertical blanking period timing diagram, in accordance with embodiments of the invention;

FIG. 2b shows a vertical blanking period timing diagram in accordance with embodiments of the invention;

FIG. 2c shows a horizontal blanking period timing diagram in accordance with embodiments of the invention;

FIG. 3 shows a display controller coupled to a memory controller, a memory and a display panel in accordance with a preferred embodiment of the invention; and

FIG. 4 shows a flow diagram in accordance with a preferred embodiment of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The subject matter presented herein enables hardware designers to achieve both enhanced application performance and enhanced visual display performance by way of a preemptive arbitration scheme. As described above, enhanced application performance results when a SoC processor is able to freely access SoC memory to retrieve and execute code. Similarly, enhanced visual display performance is the result of increased visual display controller access to memory to obtain pixel data that may be displayed on a display panel external to the SoC. The preemptive arbitration scheme controls access to memory by taking into consideration various application and display performance factors as described below. As a result, overall system performance (i.e., application and display performance) is optimized or at least improved from normal performance levels.

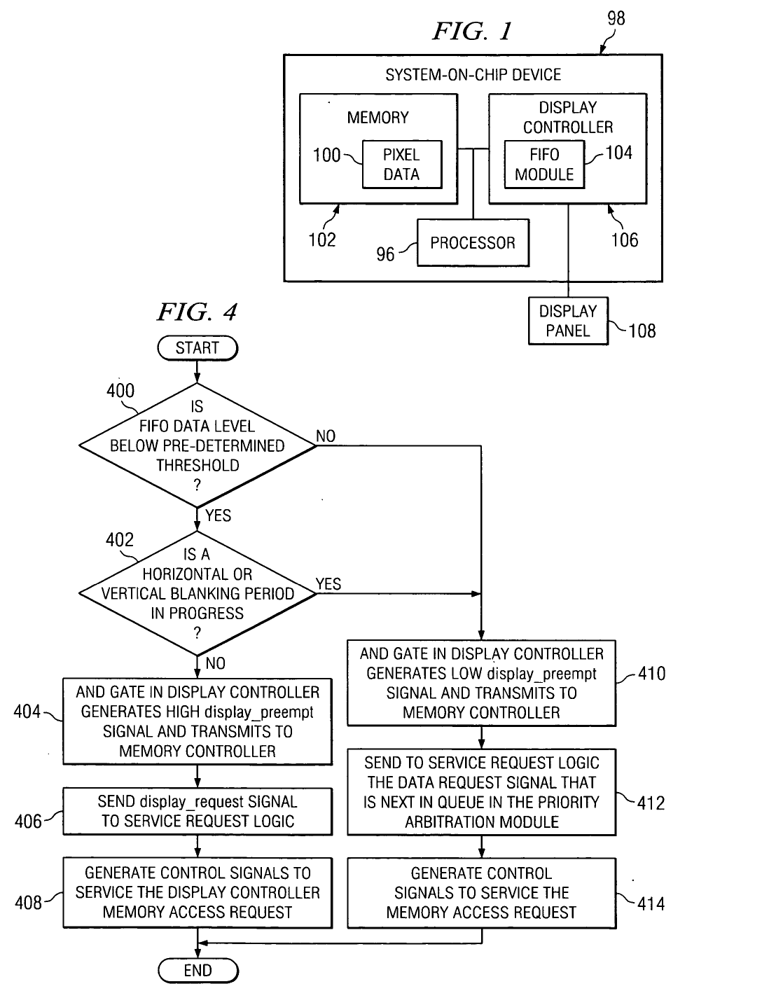

FIG. 1 shows a SoC device 98 comprising, among other things, a display controller 106 comprising a first-in, first-out module (“FIFO”) 104, a memory 102 coupled to the display controller 106, a processor 96 coupled to the memory 102 and the display controller 106, and a display panel 108 coupled to the display controller 106 and external to the SoC 98. The performance factors taken into consideration by the preemptive arbitration scheme, mentioned above, generally comprise FIFO 104 status and blanking period status, each of which will now be discussed in turn.

Before a pixel data 100 is transferred from the SoC memory 102 to the display panel 108 to be shown to an end-user, the pixel data 100 is temporarily stored in the FIFO 104. By storing at least a pre-determined amount of pixel data, the FIFO 104 ensures that the display panel 108 will be supplied with a continuous, uninterrupted flow of pixel data. Because the visual image shown on the display panel 108 may constantly be changing (e.g., a video is playing, an end-user is examining a mobile phone phonebook), the image needs to be repeatedly refreshed with new pixel data obtained from the memory 102. During such refresh operations, the display controller 106 has a higher demand for data bandwidth (i.e., “peak bandwidth”), thus resulting in an increase in the data-read rate. For example, if a “window” displaying a video on the display panel 108 is downscaled by an end-user (e.g., if the window is 100×100 pixels in memory and the end-user selects a display panel 108 video window such that the video window is only 50×50 pixels), then fewer pixels are displayed on the display panel 108 than are read from the memory 102. Such window downscaling causes pixel data to be transferred from the FIFO module 104 to the display panel 108 at a rate faster than that at which pixel data are normally transferred (i.e., the demand for bandwidth is increased). Because the rate at which pixel data are transferred between the FIFO module 104 and the display panel 108 is increased, the FIFO 104 may begin to output pixel data at a faster rate than that at which pixel data are input into the FIFO 104. Accordingly, pixel data must be transferred from the memory 102 to the FIFO 104 at a rate faster than that at which pixel data are normally accessed; otherwise, the FIFO 104 will become close to empty or actually become empty (“underflow”). Thus, during peak bandwidth intervals, it is necessary to keep the FIFO 104 from underflowing.

Conversely, there are times during a refresh operation where the display controller 106 is not transferring any pixel data from the FIFO 104 to the display panel 108. These events are known as “blanking periods.” Because pixel data are not being sent to the display panel 108 during a blanking period, during this time, a processor(s) may have increased access to the memory 102 and thus improved application performance (i.e., speed). There exist two types of blanking periods: vertical blanking periods and horizontal blanking periods. A vertical blanking period is the time between each new frame of pixel data that is displayed on the display panel 108. A horizontal blanking period is the time between each new line of pixel data (i.e., within the same frame) that is displayed on the display panel 108. Because each frame comprises multiple lines, vertical blanking periods (i.e., frame changes) are less frequent than horizontal blanking periods (i.e., line changes), but may have a longer blanking duration.

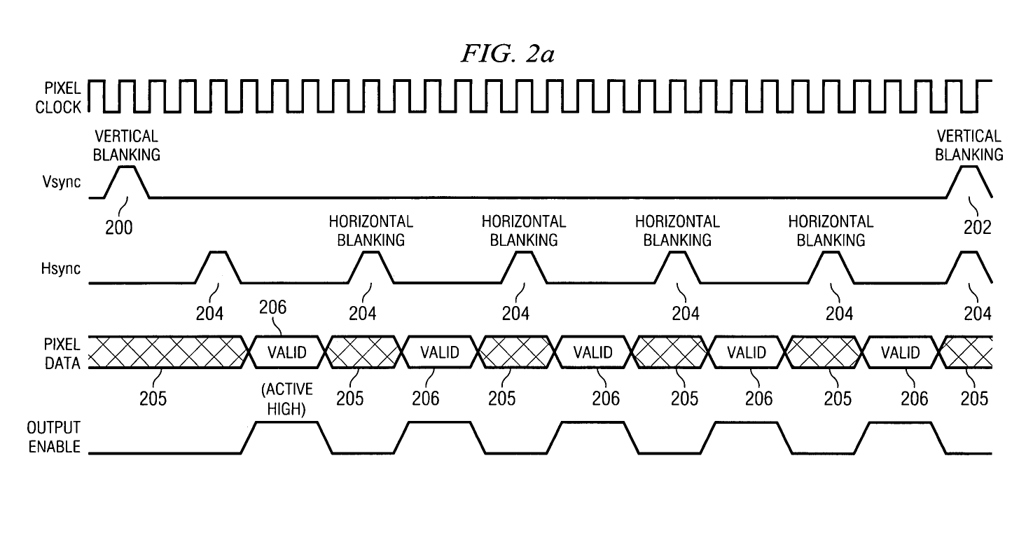

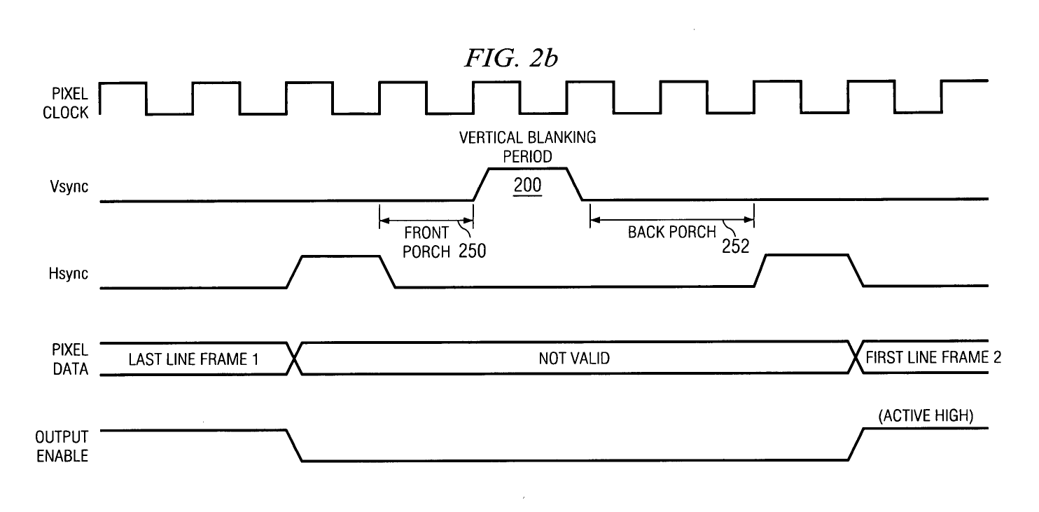

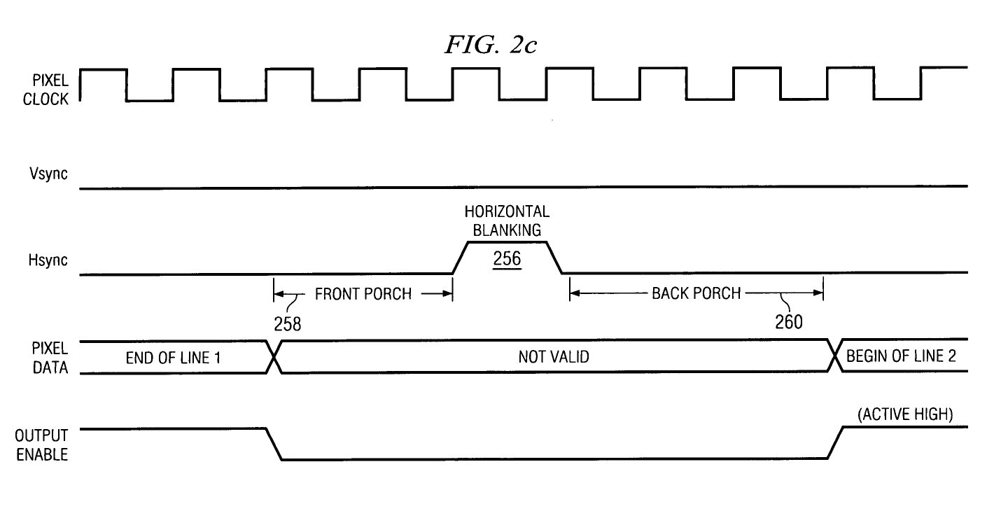

FIG. 2a illustrates a timing diagram describing when pixel data is output to the display panel 108 in relation to vertical and horizontal blanking periods. More specifically, between two vertical blanking periods 200, 202 (i.e., a single frame), multiple horizontal blanking periods 204 (i.e., periods during which lines of data are refreshed) occur. As previously explained, pixel data are not transferred to the display panel 108 during the blanking periods 200, 202, 204 and thus pixel data is not valid during these periods (indicated in the figure by hash marks 205). However, pixel data is valid during non-blanking periods (indicated by time periods 206) and may be output to the display panel 108.

FIG. 2b shows a close-up view of the vertical blanking period 200 shown in FIG. 2a. Immediately preceding the vertical blanking period 200 is a “front porch” 250 and immediately succeeding the vertical blanking period 200 is a “back porch” 252. The front porch 250 is the time period (whose length is determined by a software programmer or other such entity) immediately before the vertical sync pulse of the vertical blanking period 200, and the back porch 252 is the time period (whose length is determined by a software programmer or other such entity) immediately after the vertical blanking period 200. Similar to blanking periods, pixel data is not valid during the front porch period 250 and the back porch period 252. The pixel data generally is valid at other times.

FIG. 2c shows a close-up view of the horizontal blanking period 256 shown in FIG. 2a. A front porch 258 immediately precedes the horizontal blanking period 256 and a back porch 260 immediately follows the horizontal blanking period 256. As discussed above, pixel data is not valid during the front porch period 258, the horizontal blanking period 256 and the back porch period 260. Pixel data generally is valid at other times.

Because pixel data is not output to the display panel 108 during blanking periods and front/back porch periods, during these periods, the display controller 106 has no need to preempt, or have a higher priority than, the memory 102 to retrieve additional pixel data. Thus, during these periods, the SoC processor 96 may freely access the memory 102 to obtain and execute code, thereby substantially improving application performance. Conversely, in situations demanding an increase in the rate at which pixel data is delivered to the display panel 108 (e.g., the downscaling of a video window that is being displayed on the display panel 108), the FIFO 104 may be in danger of underflowing with an insufficient amount of pixel data. Thus, in a situation where the FIFO 104 is in danger of underflowing and has an amount of pixel data (i.e., byte level) that is below a pre-determined threshold (e.g., as determined by an end-user or software programmer, although the threshold also may be hardwired into circuit hardware), and a blanking/porch period is not in effect, the display controller 106 may generate a preempt signal and send the signal to a memory controller. This preempt signal causes the memory controller to preempt all other memory access requests to allow the display controller 106 to be serviced. The memory controller enables the display controller 106 to have access to the memory 102 during peak pixel bandwidth times so that the FIFO 104 will not underflow with an insufficient amount of pixel data.

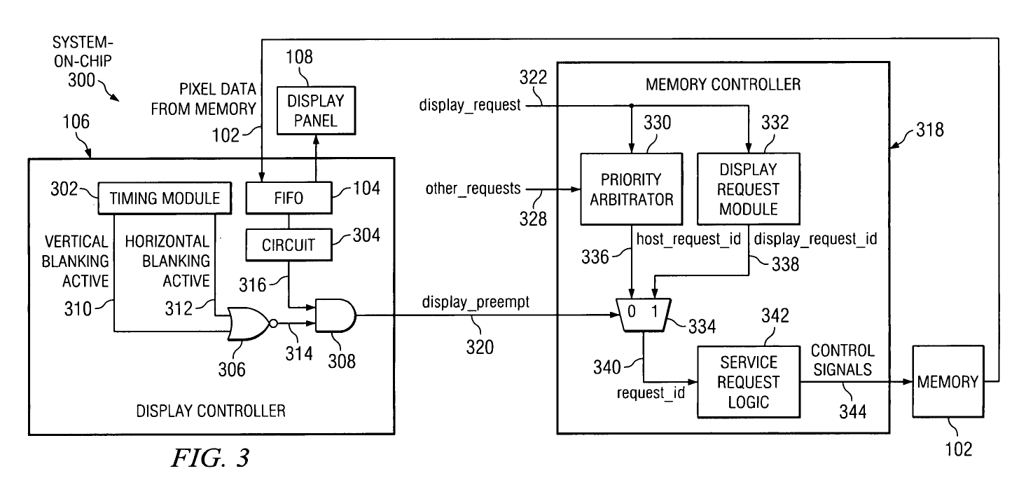

FIG. 3 illustrates a SoC 300 comprising a display panel 108, a display controller 106 and a memory controller 318. The display controller 106 may comprise a timing module 302, a FIFO 104, a FIFO status circuit 304, a NOR gate 306, and an AND gate 308. The memory controller 318 handles memory access requests by various components of the SoC 300. The memory controller 318 may comprise a priority arbitration module 330, a display request module 332, a multiplexer 334, and a service request logic 342. As explained above, during blanking/porch periods, the memory controller 318 allows the SoC 300 processor(s) to freely access the memory 102 to retrieve and execute code and enhance application performance. However, during non-blanking/porch periods, the FIFO 104 data levels may become excessively low. In such cases, the display controller 106 may sent a preempt request to the memory controller 318 to gain immediate access to memory to fill up the FIFO 104 with new pixel data.

Because preempt requests are generated by the display controller 106 when the FIFO 104 data levels are below a certain pre-determined threshold, the FIFO 104 data levels are continuously monitored by an application-specific integrated circuit (“ASIC”) 304 that is coupled to the FIFO 104. More specifically, the ASIC 304 contains minimum data threshold values that are compared with the amount of data (i.e., byte level) in the FIFO 104 (a software programmer may assign an appropriate minimum threshold level) using a byte counter or other appropriate technique. If the data level in the FIFO 104 drops below the minimum threshold level as determined by the ASIC 304, the ASIC 304 may output an active-high signal fifo_preempt_level 316. This signal 316 is fed to the AND gate 308. The AND gate 308 may generate a display_preempt signal 320 that causes the memory controller 318 to provide immediate memory 102 access to the display controller 106 if the fifo_preempt_level signal 316 is high and there is no existing vertical/horizontal blanking or porch period in session. To determine the presence of a blanking or porch period, the AND gate 308 obtains a blanking signal 314 from the NOR gate 306. The NOR gate 306 is fed an active-high vertical_blanking_signal 310 and an active-high horizontal_blanking_signal 312 from the timing module 302 (the timing module 302 also may send front/back porch signals to the NOR gate 306, but are not shown in the figure).

For example, if no blanking period is in progress, then both signals 310 and 312 will be set to low. Thus, the NOR gate 306 will output a high signal 314 to the AND gate 308. If the circuit 304 determines the FIFO 104 data level is below the predetermined threshold, the circuit 304 also will output a high signal 316 to the AND gate 308. Because both signals 314 and 316 are high, the AND gate 308 will generate a high display_preempt signal 320, indicating to the memory controller 318 that the display controller 106 must immediately access the memory 102 to prevent the FIFO 104 from underflowing with an insufficient amount of data. Conversely, if either a horizontal of vertical blanking period is in session, or if the FIFO 104 level is not below the pre-determined threshold, then the AND gate 308 will output a low display_preempt signal 320, indicating to the memory controller 318 that currently there is no immediate need for the display controller 106 to access the memory 102.

The memory controller 318 receives the display_preempt signal 320 from the display controller 106 and feeds the signal 320 to the multiplexer 334. Based on the state of the signal 320, the multiplexer will allow one of two possible memory access requests to be serviced. Specifically, if the signal 320 is high, indicating an immediate need for data for the FIFO 104, then the multiplexer 334 will select a display_request id signal 338. The display_request_id signal 338 is generated by the display request module 332, which is fed a display request signal 322. The display request signal 322 also is fed to the priority arbitration module 330. One difference between the display request module 332 and the priority arbitration module 330 is that the priority arbitration module 330 is fed memory access requests (i.e., other_requests signal 328) from various other SoC 300 components (e.g., processors) in addition to the display request signal 322 from the display controller 106. The priority arbitration module 330 assigns a priority level to each of the various memory access requests based on any appropriate method, such as a round-robin method or least-recently-used (“LRU”) method. Thus, the priority arbitration module 330 may assign top priority to any memory access request, whereas the display request module 332 assigns top priority to the memory access request from the display controller 106. If the display_preempt signal 320 is set to high by the display controller 106, then the FIFO 104 must immediately access the memory 102 and the multiplexer 334 allows the display_request_id signal 338 to be serviced. In such a case, the request_id signal 340 is assigned to the display controller 106 and is fed into the service request logic 342 for processing. The control signals 344 output from the logic 342 service the request and allow the display controller 106 to freely access the memory 102 such that the data level in the FIFO 104 is no longer below the minimum threshold value. Conversely, if the display_preempt signal 320 is set to low by the display controller 106, then the multiplexer 334 allows the host_request_id signal 336 from the priority arbitration module 330 to be serviced by the service request logic 342.

An exemplary process that may be used to implement such a preemptive arbitration scheme is shown in FIG. 4. The process begins by determining whether the FIFO 104 data level is below the pre-determined threshold (block 400). If the data level is not below the threshold, then there is no need for a preemptive signal and thus the display_preempt signal 320 is asserted low and transmitted to the memory controller 318 (block 410). The memory controller 318 then sends to the service request logic 342 the data request signal that is next in queue in the priority arbitration module 330 (block 412). Finally, the service request logic 342 generates control signals to service the memory access request obtained from the priority arbitration module 330 (block 414).

However, if the FIFO 104 data level is below the pre-determined threshold, then the absence of a blanking period is verified (block 402). If a blanking period is in progress, then the display_preempt signal 320 is asserted low and the next memory access request in queue in the priority arbitration module 330 is serviced. However, if no blanking period is in progress, then a display preempt signal is necessary. The AND gate 308 asserts the display preempt signal 320 high and transmits the signal 320 to the memory controller 318 (block 404). The service request logic 342 processes the request (block 406) and generates control signals to immediately service the display controller memory access request (block 408).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a display controller adapted to monitor a first-in, first-out module (“FIFO”) data level;
a memory controller coupled to said display controller; and
a memory coupled to said display controller and said memory controller;
wherein the memory controller permits the display controller to preemptively access the memory when the FIFO data level drops below a pre-determined threshold level and no display panel vertical or horizontal blanking periods are in progress.

2. The system of claim 1, wherein the display controller monitors the FIFO data level using a byte counter.

3. The system of claim 1, further comprising a priority arbitration module coupled to the memory controller to prioritize memory access requests.

4. The system of claim 3, wherein the priority arbitration module uses a round-robin arbitration technique.

5. The system of claim 3, wherein the priority arbitration module uses a least-recently-used (“LRU”) arbitration technique.

6. The system of claim 1, wherein the display controller asserts a signal that preempts memory access for the display controller.

7. The system of claim 1, further comprising a processor that has unrestricted access to the memory during a panel display horizontal or vertical blanking period.

8. The system of claim 1, wherein the display controller transmits a signal to the memory controller that causes the memory controller to lower display memory access request priority and to allow increased memory access to a processor if the FIFO data level is above the predetermined threshold level or if a display panel horizontal or vertical blanking period is in progress.

9. The system of claim 1, wherein the system is selected from a group consisting of a mobile phone, a camera, and a personal digital assistant.

10. A method of implementing a preemptive arbitration scheme in a system, comprising:
determining whether a FIFO data level is below a pre-determined threshold level;
determining whether a panel display frame or line shift is in progress; and
enabling a display controller to preemptively access memory if the FIFO data level is below the pre-determined threshold and no panel display horizontal or vertical blanking period is in progress.

11. The method of claim 10, further comprising disabling a display controller from immediately accessing memory if the FIFO data level is above the pre-determined threshold or a panel display horizontal or vertical blanking period is in progress.

12. The method of claim 10, further comprising enabling a processor to have unrestricted access to memory if a panel display horizontal or vertical blanking period is in progress or if the FIFO data level is above the pre-determined threshold.

13. The method of claim 12, wherein enabling the processor to have unrestricted access to memory comprises using a priority arbitration module.

14. The method of claim 10, wherein determining whether the FIFO data level is below a pre-determined threshold comprises using a byte counter.

15. The method of claim 10, wherein enabling comprises asserting a signal that preempts memory access requests not generated by the display controller.

16. The method of claim 10, further comprising enabling a priority arbitration module to prioritize memory access requests if the FIFO data level is above the pre-determined threshold level or if a display panel horizontal or vertical blanking period is in progress.

17. A system, comprising:
a means for monitoring a FIFO data level;
a means for storing coupled to the means for monitoring; and
a means for controlling the means for storing, said means for controlling coupled to the means for monitoring and the means for storing;
wherein the means for controlling permits the means for monitoring to preemptively access the means for storing when the FIFO data level drops below a pre-determined threshold level and no display panel horizontal or vertical blanking periods are in progress.

18. The system of claim 17, further comprising a means for prioritizing memory access requests coupled to the means for controlling.

19. The system of claim 17, further comprising a means for processing that has unrestricted access to the means for storing during a panel display horizontal or vertical blanking period.

20. The system of claim 17, wherein the system is a portable electronic device.
